(19) United States
(12) Patent Application Publication
(10) Pub. No.: US 2006/0013736 A1
(43) Pub. Date: Jan. 19, 2006

(54) System, substrate plate and incubation device for conducting bioassays

(76) Inventors: Herman Jacobus Blok, Retie (BE); Marinus Gerardus Johannes Van Beuningen, Oss (NL)

Correspondence Address: AMSTER, ROTHSTEIN & EBENSTEIN LLP, 90 PARK AVENUE, NEW YORK, NY, 10016, US

(21) Appl. No.: 10/511,926

(22) PCT Filed: Apr. 17, 2003
(86) PCT No.: PCT/EP03/50115

§ 371 Date: Jun. 28, 2005

(30) Foreign Application Priority Data
Apr. 19, 2002 (EP) 02076728.1
Jul. 19, 2002 (US) 60397478

(51) Int. Cl. B01L 3/00

(52) U.S. Cl. 422/99; 422/102

(57) ABSTRACT

A system for conducting bioassays comprises a substrate plate with wells, and an incubation device for holding the plate. The substrate plate comprises a microplate with an array of wells arranged in rows and columns, wherein the bottom of each well is a microarray substrate having oriented flow-through channels. The incubation device comprises an incubation chamber fox holding the microplate and a cover for sealing the incubation chamber. The incubation device has a heat block with array of openings, each opening adapted to receive a well of the microplate. A sealing gasket is provided for individually sealing each well of the microplate.

The present invention relates to a system for conducting bioassays, comprising a substrate plate with a number of wells, and an incubation device for holding the plate. The invention further relates to a substrate plate with wells, and to an incubation device for such a system.

WO 01/19517 of the same applicant discloses a system with an analytical test device comprising a substrate such as a metal oxide membrane having through-going oriented channels. Such membranes have oriented channels with well controlled diameter and advantageous chemical surface properties. When used in a bioassay the channels in at least one area of the surface of the metal oxide membrane are provided with a first binding substance capable of binding to an analyte. According to a preferred embodiment the metal oxide membrane is comprised of aluminium oxide. Reagents used in these bioassays are immobilized in the channels of the substrate and the sample fluid will be forced through the channels to be contacted with the reagents.

This known analytical test device is composed of a plastic support with an encapsulated substrate layer. Openings in the plastic support define wells with a certain diameter, said wells exposing the substrate, and the area of the substrate exposed in the well being provided with at least one binding substance specific for at least one analyte. An amount of sample fluid is added to one or more of the wells of the device, the amount of added sample fluid being calculated on the basis of the dimensions of the wells and the substrate. An alternating flow is generated through the substrate in the wells whereby the liquid volume of sample fluid is forced to pass through the channels in the substrate from the upper side of the substrate to the lower side of the substrate and back at least one time, under conditions that are favorable to a reaction between an analyte present in the sample and the binding substances. Any signal generated in any of the wells is read and from said signals the presence, amount, and/or identity of said one or more analytes are determined. When the heat block of the incubator device is covered by a transparent material, such as a glass cover, the wells can be analyzed and the reading signal can be determined through the heat block.

Improvements of this known system are described in international patent applications PCT/EP02/02446, PCT/EP02/02447 and PCT/EP02/02448 of the same applicant. The known system is not suitable for high throughput screening, as it is not automation-friendly and the number of tests in one parallel processing cycle is restricted.

The invention aims to provide a system of the abovementioned type with improved high throughput screening capabilities allowing parallel processing of a large number of arrays in automated robotic platforms.

According to the invention a system is provided, wherein the substrate plate comprises a microplate with an array of wells arranged in rows and columns, wherein the bottom of each well is a microarray substrate having oriented flow-through channels, and in that the incubation device comprises an incubation chamber for holding the microplate and a cover for sealing the incubation chamber, said incubation device having a heat block with array of openings, each opening adapted to receive a well of the microplate, wherein a sealing gasket is provided for individually sealing each well of the microplate.

In this manner a system is obtained with a microplate with wells which can be made according to a SBS standard format allowing the use of standard screening instrumentation, especially in automated robotic platforms. Using for example a microplate with an array of ninety-six wells allows a parallel processing of a large number of microarrays resulting in a very efficient high throughput screening.

The invention further provides a microplate, comprising an array of wells arranged in rows and columns, wherein the bottom of each well is a microarray substrate having oriented flow-through channels.

The invention also provides an incubation device to be used in the system of the invention.

Finally, the invention provides anpparatus for conducting high throughput screening tests, comprising a system of the invention, a device for linearly moving the incubation device along a plurality of stations including a station for loading a microplate into the incubation device, a station for dispensing a liquid into the wells of the microplate, and a reading station for individually illuminating each substrate of the microplate, wherein a device is provided for moving the incubation device with the microplate with respect to the reading station in mutually perpendicular directions.

The invention will be further explained by reference to the drawings in which embodiments of the system, the microplate and the incubation device of the invention are schematically shown.

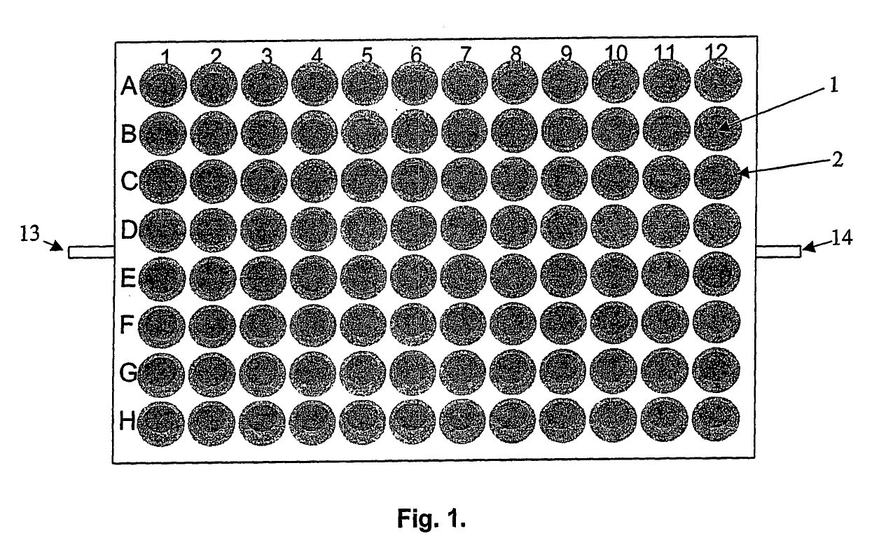

FIG. 1 shows a top view of an embodiment of the system of the invention.

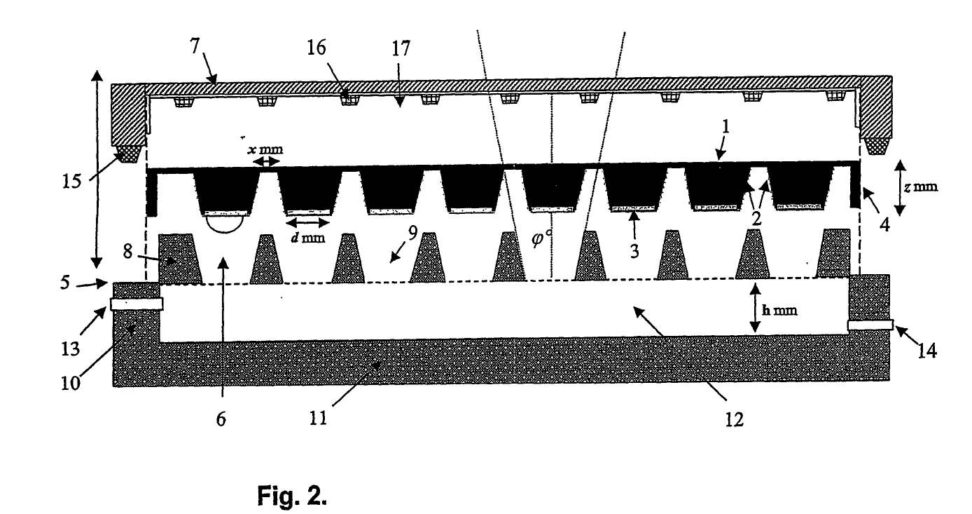

FIG. 2 is a side view of the system of FIG. 1, wherein the incubation device, the cover and the microplate are separately shown.

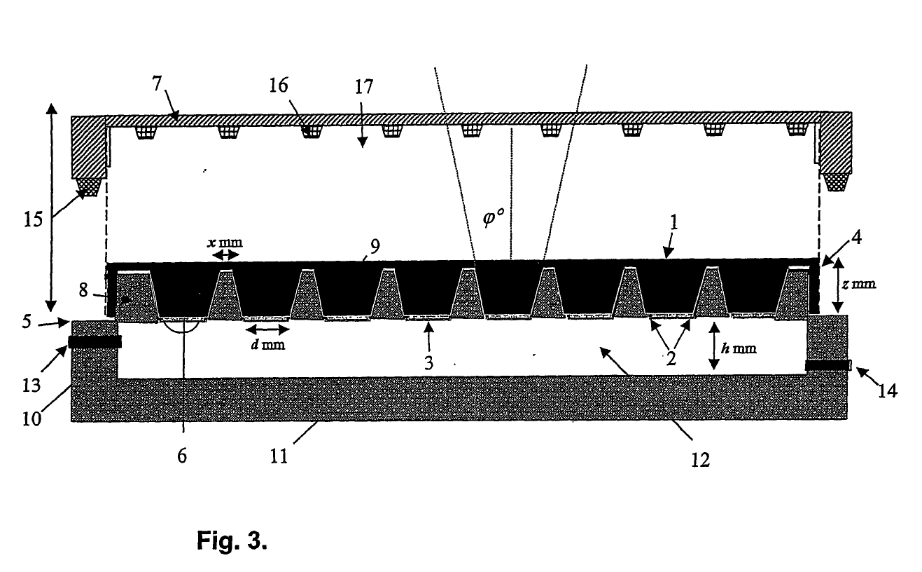

FIG. 3 shows a side view of the system of FIG. 1, wherein the wells of the microplate are located within the openings of the heat block of the incubation chamber.

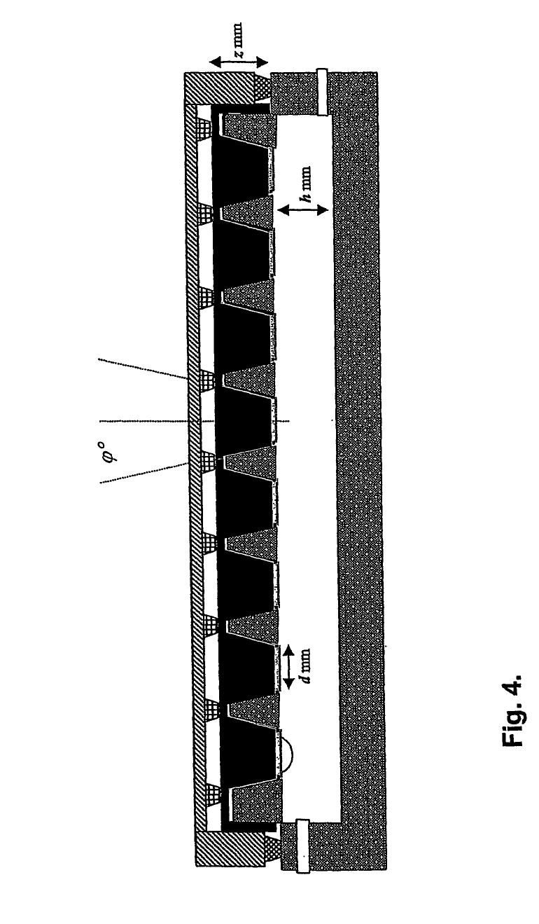

FIG. 4 is a side view of the system of FIG. 1, wherein the cover is in its closed position.

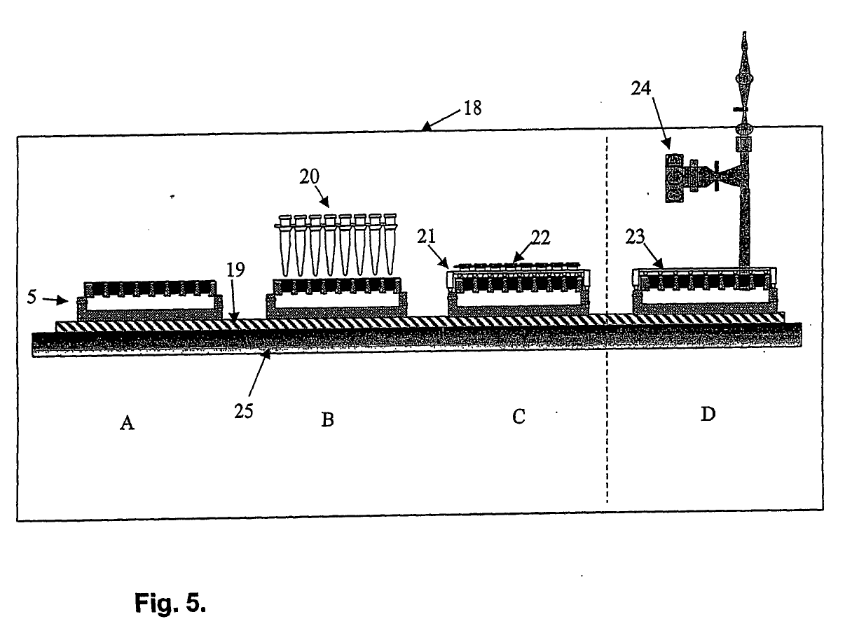

FIG. 5 shows an apparatus for performing bioassays using the system of the invention.

Referring to the drawings, there is shown a system for performing bioassays, preferably high throughput screening tests. The system comprises a microplate 1 as substrate plate, the microplate 1 having an array of wells 2 arranged in rows and columns, as can be seen in FIG. 1. In the embodiment shown, the microplate 1 comprises ninety-six wells arranged in eight rows and twelve columns. Of course other array arrangements are possible, for example with 8, 12, 24, 48, 384 or 1536 wells. As schematically shown in the side views of the system of FIGS. 2-4, the bottom of each well 2 is provided by a microarray substrate 3. The substrates 3 are located substantially in the sam virtual plane.

Each substrate 3 is made of a porous flow-through metal oxide membrane. The substrate 3 is preferably an aluminium oxide having a large number of through-going channels oriented mainly perpendicular to the upper and lower services of the substrate. Preferably the channels are capillary channels. In a practical embodiment of the substrate 3, the internal diameter d of the substrate can be 5 mm, wherein the channels may have a spacing of approximately 150-200 nm. A binding substance can be bound to the substrate in groups of channels at a spacing of 200 μm. Such a group of channels can be indicated as a spot or spot area. Each substrate 3 may have 300-400 spots or more. For a further description of the substrate material reference is made to the above-mentioned international patent application WO 01/19517. It will be understood that the number of wells, the number of spots and the dimensions are mentioned by way of example only and may be varied as desired.

In a preferred embodiment the wells 2 have a conical shape as shown in the drawings. However, the wells 2 may have a different shape. The conical shape of the wells 2 optimizes the imaging characteristics of the microplate 1, i.e. reduction of scattering and reflection of light and enablement of darkfield imaging. The microplate 1 has a skirt 4, wherein the lower side of the skirt 4 is located in the same virtual plane as the substrates 3 or is located at a higher level. Such dimensions of the skirt 4 allows an on-the-fly spotting of the substrates 3 of the microplate 1. The microplate 1 is made of a suitable plastic material, e.g. LCP, TOPAS or polypropylene, but it can also be made out of other suitable materials such as glass or silicon. The material used must be chemically resistant and heat resistant upto 120° C., robot compatible, optically compatible, i.e. flat and minimal autofluorescence. Further the material should have minimal binding properties for labeled biomolecules. Preferably the microplate material is black to minimize autofluorescence and refractive back scattering of light. As an alternative it is possible to provide the microplate 1 with a coating to obtain the desired non-reflective properties.

The substrates 3 are incorporated into the wells 2 by moulding, glueing, thermal bonding or any other suitable method. The substrates 3 are flat and are preferably located in the same virtual plane, i.e. are parallel to a virtual plane within a distance less than 100 μm.

The system further comprises an incubation device 5 providing an incubation chamber 6 for holding the microplate 1 and a cover 7 for sealing the incubation chamber 6. The incubation device 5 has a heat block 8 with an array of openings 9, each opening having a conical shape corresponding to the shape of the wells 2. The conical shape of the wells 2 provides a self-centering effect during positioning of the microplate 1 in the incubation device 5. The maximum thickness of the heat block 8 corresponds with the depth of the wells 2 of the microplate 1. In this manner the substrates 3 of the wells 2 are either projecting out of the heat block 8 or aligned flush with the lower surface of the heat block 8. Thereby a sample fluid attached to the lower surface of a substrate 3 cannot contaminate the heat block 8.

Each well is received within an opening 9, so that the outer wall of a well 2 of the microplate 1 is fitted within the inner wall of the corresponding opening 9. In this manner an optimum heat transfer from the heat block 8 to the wells 2 is obtained.

The incubation device 5 has a circumferential wall 10 and a bottom wall 11, wherein the heat block 8, the circumferential wall 10 and the bottom wall 11 enclose an air chamber 12 having a connection 13 for an external vacuum/pressure system not shown. Further, the air chamber 12 has a drain connection 14. The drain connection 14 can be closed by means of a valve not shown.

The incubation device 5 is preferably made of a metal and is providing with a heating element to control the temperature of the incubation chamber and thereby of sample fluids provided in the wells 2 of a microplate 1 received in the incubation chamber. The heating element can be made as a heating block containing one or more Peltier elements. As an alternative heat may be transferred to the incubation chamber via a water bath.

As shown in FIGS. 2-4, a sealing gasket 15 is provided on the lower side of the circumferential wall of the cover 7. As an alternative the gasket could be provided on the upper side of the circumferential wall 10 of the incubation device 5. This sealing gasket 15 seals the incubation device 5 when the cover 7 is in the closed position of FIG. 4. The air chamber 12 is then closed in an air-tight manner. A further sealing gasket 16 is provided, having circular openings 17 with a diameter corresponding to the diameter of the openings 9 at the surface of the heat block 8. Preferably the sealing gasket is sealingly fixed on the inner side of the cover 7. When the cover is in its closed position the gasket 16 sealingly engages the upper side of the microplate 1. In view of the shape of the sealing gasket 16 each well 2 of the microplate 1 is individually sealed with respect to the other wells 2 and the environment.

The cover 7 is preferably transparent and is made of glass, for example. The cover 7 can be provided with a heating element, for example by incorporating transparent electrical wires in the cover material. As an alternative a heating element having the same shape as the heat block 8 could be used for heating the cover. The cover 7 can be heated in this manner to prevent condensation during conducting a high throughput screening test. The transparency of the cover allows a real time measurement to be made from above using a CCD system or a suitable optical scanner.

During operation, the pressure in the incubation device can be controlled by a vacuum/pressure system connected to the connection 13. To perform high throughput screening bioassays, one or more sample fluids are provided in the wells 2 and the microplate 1 is inserted into the incubation chamber 6. The cover 7 is brought in its closed position as shown in FIG. 4 and the pressure within the air chamber 12 is controlled. A low pressure in the chamber 12 creates a pressure difference over the substrate 3, whereby the sample fluid is forced through the channels of the substrate 3, thereby creating a low pressure within the wells 2. By removing the low pressure in the chamber 12, the sample fluid is automatically forced back through the channels of the substrates 3 into the wells 2. Of course, it is possible to create a high pressure in the chamber 12 to force the sample fluid through the channels into the wells 2 more rapidly. By alternatingly creating a low pressure in the chamber 12 and removing the low pressure, the sample fluids are forced through the channels of the substrate a number of times. The individual sealing of each of the wells 2 shows the advantage that a malfunction of one of the substrates 3, which prevents the creation of a pressure difference over the substrate, will not prevent normal use of the other substrates 3.

The imaging of the bioassay is done from above through the transparent cover 7 using a CCD camera for example. This allows a real time kinetic measurement. The height h of the chamber 12 is such that a standard microplate with a corresponding array of wells can be located in the chamber 12 to collect filtrate from the microplate 1. The chamber 12 can further be used as a humidifying chamber by releasing a small amount of liquid in the chamber. Thereby evaporation of sample liquid is significantly reduced at elevated temperatures and during extended operations. Flow-through washing of the substrates 3 is possible. The drain connection 14 allows the disposal of the washing liquids.

Preferably the incubation device 5 is part of an apparatus for conducting high throughput screening tests, an embodiment of which is shown in a very schematical manner in FIG. 5. According to FIG. 5, the apparatus comprises a platform 18 supporting a device 19 for linearly moving the incubation device S. By means of the device 19, the incubation device 5 can be positioned with great accuracy in the X-direction at the locations A-D indicated in FIG. 5. In location A, the incubation device 5 is in a position for loading a microplate 1 into the device 5 by means of a robot. A dispenser station 20 is located in position B. This station 20 is adapted to dispense a washing liquid into the wells 2 of the microplate 1. After treatment of the microplate 1 at the location B, the incubation device 5 is moved into position C, where a further treatment of the microplate 1 is possible. For this treatment a special cover 21 is placed on the incubation device 5. This cover 21 is provided with an array of needles 22 corresponding with the array of wells 2 of the microplate 1. Through these needles 22, the pressure within the wells 22 above the substrates 3 can be increased to facilitate the flow of the sample liquid through the substrates 3. Further, air can be blown on the substrates 3 through these needles 22.

A reading station 24 is provided at the location D. In order to read each of the substrates 3 the platform 18 is moveable in X and Y-direction. In this manner each substrate 3 can be illuminated by a radiation source of the reading station 24 and the fluorescence is read by means of a CCD camera of the reading station 24. Instead of the illumination shown in FIG. 5, a so-called dark field illumination, i.e. illumination under an angle with respect to the substrate, is also possible.

Preferably, a microplate 1 is used meeting the standard format as proposed by the Society for Biomolecular Screening (SBS) for microplates. This allows the use of current industry standards for screening applications and screening instrumentation, especially the use of automated robotic platforms In this manner, the system as described can be used in applications such as genotyping, including SNP analysis, gene expression profiling, proteomics, ELISA-based bioassays, receptor-ligand binding bioassays and enzyme kinetic bioassays.

It will be understood that the system of the invention allows parallel processing of a large number of microarrays. A sequential fluorescent detection of the microarrays by imaging per well is facilitated by the flatness and location of the substrates in the same virtual plane. Further the dimensions of the wells, in particular the conical shape of the wells allows the sequential fluorescent detection. The system is adapted to automation and is robot compatible. The individual sealing of the wells shows the advantage that in case of substrate breakage there is no interference of the control of the pressure variation at the other substrates. The microplate 1 allows for an on the fly spotting of the binding agents.

The invention is not restricted to the above-described embodiment which can be varied in a number of ways within the scope of the claims.

1. System for conducting bioassays, comprising a substrate plate with a number of wells, and an incubation device for holding the plate, characterized in that the substrate plate comprises a microplate with an array of wells arranged in rows and columns, wherein the bottom of each well is a microarray substrate having oriented flow-through channels, and in that the incubation device comprises an incubation chamber for holding the microplate and a cover for sealing the incubation chamber, said incubation device having a heat block with array of openings, each opening adapted to receive a well of the microplate, wherein a sealing gasket is provided for individually sealing each well of the microplate.

2. System according to claim 1, wherein the incubation device comprises a circumferential wall, wherein a sealing gasket is provided on the upper side of said circumferential wall, said sealing gasket being adapted to sealingly engage the lower side of the microplate.

3. System according to claim 1, wherein the maximum thickness of the incubation device heat block corresponds with the depth of the wells of the microplate, wherein preferably the circumferential wall of each opening is adapted to contact the outer wall of a well of the microplate.

4. System according to claim 3, wherein the wells of the microplate and the openings of the heat block are conically shaped.

5. System according to claim 1, wherein the heat block, the circumferential wall and a bottom wall of the incubation device enclose an air chamber having a connection for an external vacuum/pressure system and a drain connection.

6. System according to claim 1, wherein the cover is transparent.

7. System according to claim 1, wherein the cover is provided with a heating element.

8. System according to claim 1, wherein the incubation device is provided with a heating element.

9. System according to claim 1, wherein the substrate is made of a metal oxide, preferably an aluminium oxide.

10. Microplate, comprising an array of wells arranged in rows and columns, wherein the bottom of each well is a microarray substrate having oriented flow-through channels.

11. Microplate according to claim 10, wherein each well has a conical shape.

12. Microplate according to claim 10, wherein at least the upper surface of the microplate and the inner side of the wells is non-reflecting.

13. Microplate according to claim 10, comprising a skirt having a lower side, wherein the substrates of the wells are substantially located in the same virtual plane and the lower side of the skirt is located in the same virtual plane or at a higher level.

14. Microplate according to claim 10, wherein all substrates are substantially located in the same virtual plane.

15. Microplate according to claim 10, wherein the substrates are incorporated in the plate by moulding, glueing, thermal bonding or the like.

16. Microplate according to claim 10, wherein the substrate is made of a metal oxide, preferably an aluminium oxide.

17. Incubation device for a system according to claim 1.

18. Apparatus for conducting high throughput screening tests, comprising a system according to claim 1, a device for linearly moving the incubation device along a plurality of stations including a station for loading a microplate into the incubation device, a station for dispensing a liquid into the wells of the microplate, and a reading station for individually illuminating each substrate of the microplate, wherein a device is provided for moving the incubation device with the microplate with respect to the reading station in mutually perpendicular directions.
